(19) United States
(12) Patent Application Publication
(10) Pub. No.: US 2026/0162015 A1
(43) Pub. Date: Jun. 11, 2026

(54) DEVICE AND METHOD FOR CONTINUAL LEARNING

(71) Applicant: UIF (University Industry Foundation), Yonsei University, Seoul (KR)

(72) Inventors: Sung Bae CHO, Seoul (KR); Hyung Jun MOON, Seoul (KR)

(73) Assignee: UIF (University Industry Foundation), Yonsei University, Seoul (KR)

(21) Appl. No.: 19/408,827

(22) Filed: Dec. 4, 2025

(30) Foreign Application Priority Data
Dec. 5, 2024 (KR) 10-2024-0179916

(51) Int. Cl. G06N 20/00

(52) U.S. Cl. CPC G06N 20/00

(57) ABSTRACT

According to an embodiment of the disclosure, a continual learning apparatus for performing continual learning with respect to a model includes: a memory configured to store the model; an input device configured to receive first input data; and a processor configured to convert the first input data into a first feature vector, convert the first feature vector into a multivariate Gaussian distribution and store the multivariate Gaussian distribution in the memory, perform first learning with respect to the model based on the first input data, and when second input data is received, perform second learning with respect to the model by using the multivariate Gaussian distribution with respect to the first input data and the second input data.

### CROSS-REFERENCE TO RELATED APPLICATION

This application claims the benefit of Korean Patent Application No. 10-2024-0179916, filed on Dec. 5, 2024, in the Korean Intellectual Property Office, under 35 U.S.C. § 119(a), the entire disclosure of which is incorporated herein by reference in its entirety.

### BACKGROUND

### 1. Field

The disclosure relates to a continual learning apparatus and method that perform continual learning with respect to a model.

### 2. Discussion of Related Art

Continual learning refers to an important research field in which a learning target model continuously learns new data while preventing forgetting of previously learned information.

Techniques for continual learning according to the related art have presented various approaches to solve a catastrophic forgetting problem, but degradation of learning performance due to changes in data distribution and loss of existing knowledge still remain.

In addition, in the related-art continual learning techniques, spatial inefficiency occurs due to additional memory usage caused by storing unnecessary redundant information.

### SUMMARY

The disclosure aims to solve the aforementioned problems of the related art, and an objective thereof is to solve a forgetting problem that occurs during a process of preserving past data and learning new data in continual learning by combining a multivariate Gaussian distribution and a contrastive learning technique.

### TECHNICAL SOLUTION

According to an embodiment of the disclosure, in a continual learning apparatus that performs continual learning with respect to a model,

the continual learning apparatus may include: a memory configured to store the model; an input device configured to receive first input data; and a processor configured to convert the first input data into a first feature vector, convert the first feature vector into a multivariate Gaussian distribution and store the multivariate Gaussian distribution in the memory, perform first learning with respect to the model based on the first input data, and when second input data is received, perform second learning with respect to the model by using the multivariate Gaussian distribution with respect to the first input data and the second input data.

In addition, the processor may be configured to perform contrastive learning with respect to the first input data and extract the first feature vector.

In addition, the processor may be configured to structure the first feature vector in a latent space through contrastive learning with respect to the first input data.

In addition, the processor may be configured to use a triplet loss function to make data of a same class be located relatively close to each other in the latent space and make data of different classes be located relatively far from each other.

In addition, the processor may be configured to store the first feature vector in the memory in a form of a mean value and a covariance value.

In addition, an amount of information of the mean value and the covariance value of the first feature vector may be less than an amount of information of the first input data or an amount of information of the first feature vector.

In addition, the processor may be configured to classify labels of the first input data and the second input data by using the multivariate Gaussian distribution with respect to the first input data and the second input data.

In addition, the processor may be configured to regenerate the first feature vector from the multivariate Gaussian distribution with respect to the first input data, perform contrastive learning with respect to the second input data and extract a second feature vector, and perform the second learning based on the first feature vector and the second feature vector.

In addition, the processor may be configured to combine the first feature vector and the second feature vector, and classify labels of the first input data and the second input data based on a combined feature vector.

In addition, the processor may be configured to reduce interference between the first feature vector and the second feature vector by using an orthogonal weight modification (OWM) technique.

In addition, the processor may set a gradient direction of a model according to a result of previous first learning as a perpendicular direction of second learning performed currently.

In addition, the processor may be configured to adjust a distance in a latent space of the first input data and the second input data.

According to another embodiment of the disclosure, in a method of performing continual learning with respect to a model by a continual learning apparatus, the method may include: receiving first input data; converting the first input data into a first feature vector; converting the first feature vector into a multivariate Gaussian distribution and storing the multivariate Gaussian distribution in the continual learning apparatus; performing first learning with respect to the model based on the first input data; and when second input data is received, performing second learning with respect to the model by using the multivariate Gaussian distribution with respect to the first input data and the second input data.

In addition, the method may further include performing contrastive learning with respect to the first input data and extracting the first feature vector.

In addition, the method may further include structuring the first feature vector in a latent space through contrastive learning with respect to the first input data.

In addition, the method may further include, by using a triplet loss function, making data of a same class be located relatively close to each other and making data of different classes be located relatively far from each other in the latent space.

In addition, the method may further include storing the first feature vector in the continual learning apparatus in a form of a mean value and a covariance value.

According to the disclosure, performance of continual learning in artificial intelligence and deep learning models may be remarkably improved.

In addition, according to the disclosure, when new data is learned, existing knowledge may be preserved and interference between classes may be minimized to improve adaptability of a model.

In addition, according to the disclosure, as a data distribution changes, the model may be prevented from losing existing knowledge.

In addition, according to the disclosure, by utilizing the Gaussian distribution stored in the memory to reproduce past data, unnecessary data redundancy may be avoided and efficiency of memory usage may be maximized.

### BRIEF DESCRIPTION OF THE DRAWINGS

FIG. 1 is a flowchart illustrating a continual learning method according to an embodiment of the disclosure.

FIG. 2 is a block diagram illustrating a configuration of a continual learning apparatus according to an embodiment of the disclosure.

FIG. 3 illustrates detailed components of a contrastive learning apparatus for continual learning using a multivariate Gaussian distribution according to an embodiment of the disclosure.

FIG. 4 illustrates a diagram visualizing a detailed configuration of the continual learning apparatus of FIG. 3.

FIG. 5 illustrates a process of storing a multivariate Gaussian distribution.

FIG. 6 illustrates a process of orthogonal weight modification for a result of first learning.

### DETAILED DESCRIPTION

### Explanation of Terms of the Present Specification

All embodiments described below are merely examples provided to assist in understanding the disclosure, and may be implemented in various forms modified differently from the embodiments described herein. In addition, in describing the disclosure, specific descriptions of well-known functions or well-known components may be omitted when it is determined that the detailed description thereof may unnecessarily obscure the gist of the disclosure.

Attached drawings are not drawn to an actual scale for ease of understanding the disclosure and may show dimensions of some components exaggerated. When reference numerals are assigned to components, identical components are assigned identical reference numerals as much as possible even if shown in different drawings.

In describing components of the embodiments of the disclosure, terms such as first, second, A, B, (a), and (b) may be used. These terms are used only for distinguishing one component from another, and do not limit essence, order, or sequence of the corresponding components. When a component is described as being “connected,” “coupled,” or “linked” to another component, the component may be directly connected, coupled, or linked to the other component, but it should be understood that another component may be interposed therebetween.

Accordingly, configurations described in the present specification and illustrated in the drawings represent only the most preferred embodiments of the disclosure and do not represent all technical ideas of the disclosure, so various modified embodiments may exist.

In addition, terms or words used in the present specification and the claims should not be construed as being limited to common or dictionary meanings, and should be interpreted in a meaning and concept consistent with the technical idea of the disclosure, based on the principle that an inventor may define concepts of terms to optimally describe his or her own disclosure.

Additionally, singular expressions used in the present application include plural expressions unless the context clearly indicates otherwise.

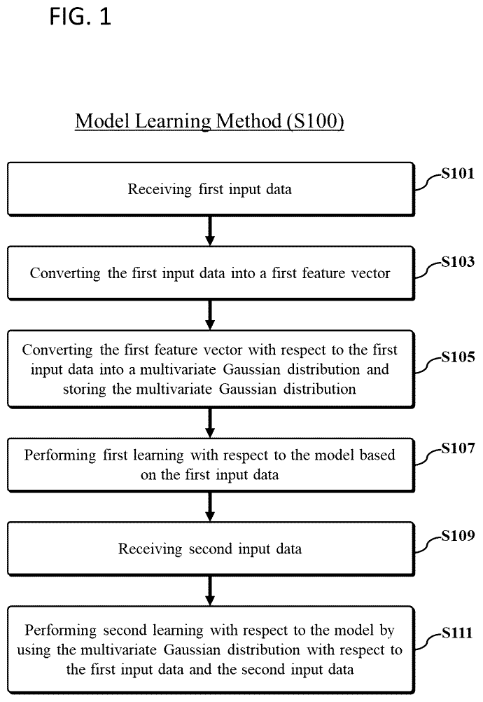

### Continual Learning Method According to an Embodiment: FIG. 1

FIG. 1 is a flowchart illustrating a continual learning method (S100) according to an embodiment of the disclosure, including steps S101, S103, S105, S107, S109, and S111, detailed as follows.

First, the continual learning apparatus receives first input data (S101).

Next, the continual learning apparatus converts the first input data into a first feature vector (S103).

Here, the continual learning apparatus may perform contrastive learning with respect to the first input data and extract the first feature vector.

For example, the continual learning apparatus may structure the first feature vector in a latent space through contrastive learning with respect to the first input data.

For example, the continual learning apparatus may use a triplet loss function to locate data of a same class relatively close to each other and locate data of different classes relatively far from each other in the latent space.

Next, the continual learning apparatus converts the first feature vector with respect to the first input data into a multivariate Gaussian distribution and stores the multivariate Gaussian distribution in a memory (S105).

Here, the continual learning apparatus may store the first feature vector in the memory in a form of a mean value and a covariance value. For example, an amount of the mean value and the covariance value may occupy less memory than an amount of the first input data or an amount of the first feature vector.

Next, the continual learning apparatus performs first learning with respect to the model based on the first input data (S107).

Next, the continual learning apparatus receives second input data (S109).

Next, the continual learning apparatus performs second learning with respect to the model by using the multivariate Gaussian distribution with respect to the first input data and the second input data (S111).

Here, the continual learning apparatus may classify labels of the first input data and the second input data by using the multivariate Gaussian distribution with respect to the first input data and the second input data.

In addition, the continual learning apparatus may regenerate the first feature vector from the multivariate Gaussian distribution with respect to the first input data, and perform contrastive learning with respect to the second input data and extract a second feature vector.

In addition, the continual learning apparatus may combine the first feature vector and the second feature vector, and classify labels of the first input data and the second input data based on the combined feature vector. For example, the continual learning apparatus may reduce interference between the first feature vector and the second feature vector by using an orthogonal weight modification technique. For example, the continual learning apparatus may set a gradient direction of the model obtained from the first learning to be perpendicular to a gradient direction used for the second learning.

In addition, the continual learning apparatus may adjust a distance in a latent space of the first input data and the second input data.

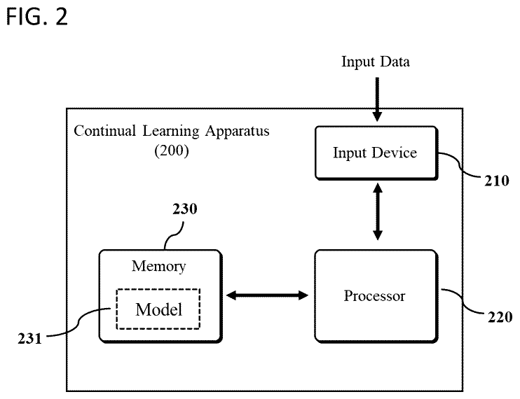

### Continual Learning Apparatus According to an Embodiment: FIG. 2

FIG. 2 is a block diagram illustrating a configuration of a continual learning apparatus according to an embodiment of the disclosure.

As illustrated in FIG. 2, a continual learning apparatus 200 may include an input device 210, a processor 220, and a memory 230.

The input device 210 may perform steps S101 and S109 described above with reference to FIG. 1.

Specifically, the input device 210 may receive first input data and second input data from outside. The input device 210 may deliver the received first input data and second input data to the processor 220.

The processor 220 may perform steps S103, S105, S107, and S111 described above with reference to FIG. 1.

Specifically, the processor 220 may convert delivered first input data into a first feature vector, and may convert second input data into a second feature vector. In addition, the processor 220 may convert the first feature vector with respect to the first input data into a multivariate Gaussian distribution and may store the multivariate Gaussian distribution in the memory 230. In addition, the processor 220 may perform first learning with respect to a model 231 stored in the memory based on the first input data. In addition, the processor 220 may perform second learning with respect to the model by using the multivariate Gaussian distribution with respect to the first input data and the second input data.

The memory 230 may store a model 231 used for learning.

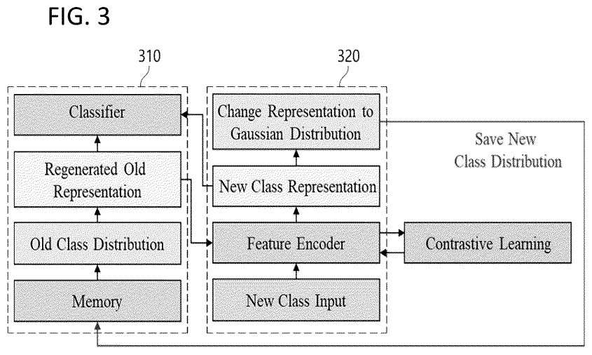

### Example of Structure of Continual Learning Apparatus: FIG. 3

FIG. 3 illustrates detailed components of a contrastive learning apparatus for continual learning using a multivariate Gaussian distribution.

As illustrated in FIG. 3, continual learning apparatuses 310 and 320 may efficiently learn features of a new task when new data is input while not losing previous knowledge.

In addition, the continual learning apparatus according to an embodiment of the disclosure includes multiple stages of processes that convert input data into a Gaussian distribution, store the Gaussian distribution in a memory, and reuse and classify the Gaussian distribution in a later task.

Specifically, a feature embedding module embedded in the processor 220 performs operations using a Feature Encoder of FIG. 3, receives original data of a new class, and may generate a representation of the new class. Here, the feature embedding module prevents an extracted old data representation from the memory from overlapping and preserves previous knowledge as much as possible. Here, the processor may perform the above-described operations by using triplet loss based on contrastive learning.

In addition, the processor may perform two processes by using the memory. Specifically, a knowledge storage module of the processor converts data and class representations composed of random vectors into Gaussian representations. In this case, since a multivariate Gaussian distribution may be expressed by a mean and covariance, the knowledge storage module stores previous knowledge in the memory in a form of a mean and covariance for each class to minimize usage of memory space. In addition, a knowledge regeneration module of the processor may regenerate data for each class by using a mean and covariance when regenerating previous knowledge.

A classification module of the processor may classify labels of each class by using the data representation. A classifier receives, as input, representation vectors of data, not original data, and therefore receives, as input, representation vectors of old classes output from the knowledge regeneration module of the memory and representations of new classes extracted by the feature embedding module, and outputs appropriate answers.

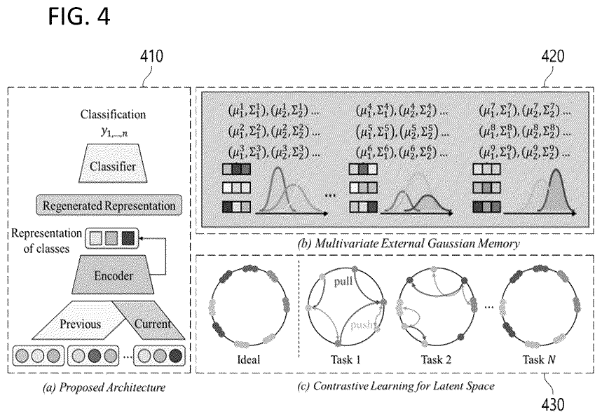

### Visualization of Continual Learning Apparatus: FIG. 4

FIG. 4 illustrates a diagram visualizing a detailed configuration of the continual learning apparatus of FIG. 3.

As illustrated in FIG. 4, FIG. 4(a) (410) illustrates a process in which new data and old data pass through until achieving an object of continual learning, which is improvement of classification performance.

FIG. 4(b) (420) illustrates multivariate Gaussian distributions, which are converted and expressed by a mean and covariance for each class, stored in a memory. Since this stores less information compared to a method of storing all data representing each class, efficient memory space may be achieved. In addition, compared to a method of storing some data, the proposed method may convert all data information into a Gaussian distribution after checking all data, and thus excellence in terms of information amount may be expected.

FIG. 4(c) (430) illustrates a contrastive learning method for preventing new class information from overlapping previous class information in the feature embedding module. When new class information is input, learning is performed so that a new class is located far from previous classes in a latent space, and data of a same class is located close.

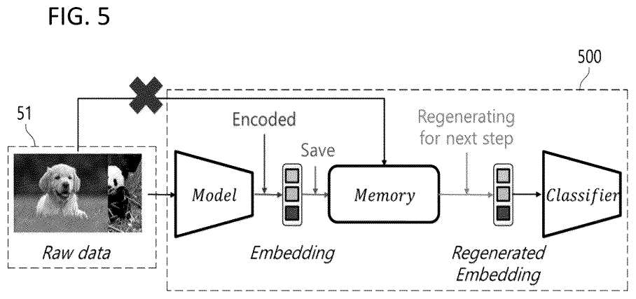

### Process of Storing Multivariate Gaussian Distribution: FIG. 5

FIG. 5 illustrates a process of storing a multivariate Gaussian distribution.

In FIG. 5, a relationship between a memory and a feature embedding module of a processor is illustrated. The processor does not store original data in the memory but converts the original data into a data representation through the feature embedding module.

The data representation may be changed into a Gaussian representation to be stored in the memory.

The Gaussian representation may be changed again into a representation for knowledge preservation and regeneration in a later process.

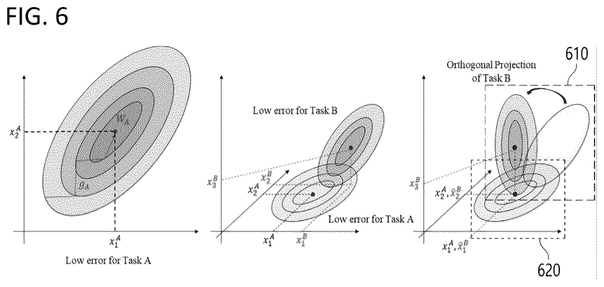

### Process of Orthogonal Weight Modification: FIG. 6

FIG. 6 illustrates a process of orthogonal weight modification for a result of first learning.

As illustrated in FIG. 6, previous knowledge of the feature embedding module of the processor may be preserved through a process of orthogonal weight modification.

As illustrated in FIG. 6, although previous knowledge appears to be perfectly preserved by storing previous class knowledge in the memory, these representations are outputs generated from a Feature Encoder of the feature embedding module, and thus a need arises to preserve a latent space where these representations are expressed.

Accordingly, the processor according to an embodiment of the disclosure preserves an old knowledge generated according to a result of previous learning through an orthogonal regularization method.

According to the technique, when a model learns, a direction of a gradient is set perpendicular to a current direction to prevent interference with respect to previous knowledge, and thus the feature embedding module preserves knowledge as much as possible.

### Interpretation of the Present Specification

Although the embodiments of the disclosure have been described in more detail with reference to the accompanying drawings, the disclosure is not limited to the embodiments, and may be variously modified without departing from the technical idea of the disclosure.

Accordingly, the embodiments disclosed herein are not intended to limit the technical idea of the disclosure but to describe the disclosure, and the scope of the disclosure should not be limited by the embodiments. Therefore, the embodiments described above should be understood as being illustrative in all respects and not restrictive. The scope of protection of the disclosure should be interpreted by the appended claims, and all technical ideas equivalent thereto should be interpreted as being included in the scope of rights of the disclosure.

What is claimed is:

1. A continual learning apparatus for performing continual learning with respect to a model, the continual learning apparatus comprising:
a memory configured to store the model;
an input device configured to receive first input data; and
a processor configured to convert the first input data into a first feature vector,
convert the first feature vector into a multivariate Gaussian distribution and store the multivariate Gaussian distribution in the memory,
perform first learning with respect to the model based on the first input data, and
when second input data is received, perform second learning with respect to the model by using the multivariate Gaussian distribution with respect to the first input data and the second input data.

2. The continual learning apparatus of claim 1,
wherein the processor is configured to perform contrastive learning with respect to the first input data and extract the first feature vector.

3. The continual learning apparatus of claim 2,
wherein the processor is configured to structure the first feature vector in a latent space through contrastive learning with respect to the first input data.

4. The continual learning apparatus of claim 3,
wherein the processor is configured to use a triplet loss function to make data of a same class be located relatively close to each other in the latent space and make data of different classes be located relatively far from each other.

5. The continual learning apparatus of claim 1,
wherein the processor is configured to store the first feature vector in the memory in a form of a mean value and a covariance value.

6. The continual learning apparatus of claim 5,
wherein an amount of information of the mean value and the covariance value of the first feature vector is less than an amount of information of the first input data or an amount of information of the first feature vector.

7. The continual learning apparatus of claim 1,
wherein the processor is configured to classify labels of the first input data and the second input data by using the multivariate Gaussian distribution with respect to the first input data and the second input data.

8. The continual learning apparatus of claim 1,
wherein the processor is configured to regenerate the first feature vector from the multivariate Gaussian distribution with respect to the first input data,
perform contrastive learning with respect to the second input data and extract a second feature vector, and
perform the second learning based on the first feature vector and the second feature vector.

9. The continual learning apparatus of claim 1,
wherein the processor is configured to combine the first feature vector and a second feature vector,
and classify labels of the first input data and the second input data based on a combined feature vector.

10. The continual learning apparatus of claim 9,
wherein the processor is configured to reduce interference between the first feature vector and the second feature vector by using an orthogonal weight modification (OWM) technique.

11. The continual learning apparatus of claim 10,
wherein the processor is configured to set a gradient direction of the model obtained from the first learning to be perpendicular to a gradient direction used for the second learning

12. The continual learning apparatus of claim 1,
wherein the processor is configured to adjust a distance in a latent space of the first input data and the second input data.

13. A method for performing continual learning with respect to a model by a continual learning apparatus, the method comprising:
receiving first input data;
converting the first input data into a first feature vector;
converting the first feature vector into a multivariate Gaussian distribution and storing the multivariate Gaussian distribution in the continual learning apparatus;
performing first learning with respect to the model based on the first input data; and
when second input data is received, performing second learning with respect to the model by using the multivariate Gaussian distribution with respect to the first input data and the second input data.

14. The method of claim 13,
further comprising performing contrastive learning with respect to the first input data and extracting the first feature vector.

15. The method of claim 14,
further comprising structuring the first feature vector in a latent space through contrastive learning with respect to the first input data.

16. The method of claim 15,
further comprising, by using a triplet loss function, making data of a same class be located relatively close to each other and making data of different classes be located relatively far from each other in the latent space.

17. The method of claim 13,
further comprising storing the first feature vector in the continual learning apparatus in a form of a mean value and a covariance value.
